(19) United States
(12) Patent Application Publication
(10) Pub. No.: US 2025/0041821 A1
(43) Pub. Date: Feb. 6, 2025

(54) REACTOR DEVICE AND METHOD FOR CARRYING OUT PHOTOCHEMICAL REACTIONS WITH A REACTOR DEVICE

(71) Applicants: EKATO RÜHR- UND MISCHTECHNIK GMBH, Schopfheim (DE); PESCHL ULTRAVIOLET GMBH, Mainz (DE)

(72) Inventors: Dr. Konstantin EPP, Lörrach (DE); Dr. Wolfgang LAST, Lörrach (DE); Alexander PESCHL, Mainz (DE); Marco KÖNIG, Schopfheim (DE)

(21) Appl. No.: 18/717,050

(22) PCT Filed: Dec. 6, 2022
(86) PCT No.: PCT/EP2022/084510

§ 371 Date: Jun. 6, 2024

(30) Foreign Application Priority Data
Dec. 6, 2021 (DE) 10 2021 132 074.7

(51) Int. Cl. B01J 19/12; B01J 19/00; B01J 19/18

(52) U.S. Cl. CPC B01J 19/122; B01J 19/0066; B01J 19/18; B01J 2219/1203

(57) ABSTRACT

A reactor device comprises a reaction vessel for receiving at least one medium, wherein
the reactor device comprises an external irradiation unit that is arranged outside the reaction vessel, with at least one external radiation element, for an irradiation of the medium within the reaction vessel.

### CROSS-REFERENCE TO RELATED APPLICATIONS

This patent application is a U.S. national stage application of international patent application PCT/EP2022/084510, filed on Dec. 6, 2022, which is based on and claims priority to German patent application DE 10 2021 132 074.7, filed on Dec. 6, 2021, the contents of which are incorporated herein by reference.

### PRIOR ART

The invention concerns a reactor device and a method for carrying out photochemical reactions with a reactor device.

Reactors with a reaction vessel for receiving media are already known from the prior art. For carrying out photochemical reactions within the reaction vessel, for example for a depolymerization of plastics or for a chlorination of polyvinylchloride (PVC) to produce PVC-C, an irradiation of the media with electromagnetic radiation, for example UV radiation, is required. In already-known reactors, radiation sources for supplying the electromagnetic radiation are arranged within the reaction vessel. This may result in disadvantages for the conduction of the method, for example as a size or an arrangement of agitators is limited due to the internal radiation sources arranged within the reaction vessel, and/or as operating pressures are limited by a pressure resistance of the internal radiation sources, such that for a great number of photochemical reactions customary reactors will have reduced efficiency.

The objective of the invention is in particular to provide a generic device having advantageous characteristics with regard to efficiency. The objective is achieved according to the invention.

### Advantages of the Invention

The invention is based on a reactor device with a reaction vessel for receiving at least one medium.

It is proposed that the reactor device comprises an external irradiation unit that is arranged outside the reaction vessel, with at least one external radiation element, for an irradiation of the medium within the reaction vessel.

Such an implementation advantageously allows providing a reactor device with improved efficiency. In particular, efficient process management is achievable and the volume of the reaction vessel can be utilized in a particularly efficient manner. Moreover, an especially high degree of flexibility is advantageously attainable. Depending on a type of the chemical reactions that are to be carried out in the reaction vessel and on the reactants used for such chemical reactions, respectively on the products produced by such chemical reactions, it is in particular possible to use a wide variety of agitators in the reaction vessel.

A “reactor device” is to mean an, in particular functioning, component, in particular a structural and/or functional component, of a reactor, in particular of a photoreactor. The reactor device may as well comprise the entire reactor. Preferably the reactor device is realized as a photoreactor device. The reactor device and/or the reactor comprising the reactor device is configured, without being limited to, for carrying out photochemical reactions, for example for a depolymerization of plastics or for a chlorination of polyvinylchloride (PVC) to form PVC-C or for a photo-initiated polymerization of monomers into synthetic resins and/or adhesives.

The reaction vessel comprises a vessel bottom and at least one sidewall, which together form an inner vessel space for receiving the at least one medium. Preferably the vessel bottom and the sidewall are implemented integrally. “Integrally” is to mean connected by substance-to-substance bond, like for example by a welding process and/or gluing process etc., and especially advantageously molded-on, e. g. by a production from a cast and/or by a production in a one-component or multi-component injection-molding procedure. The vessel bottom and the sidewall are preferably made of a metal and/or of a metal alloy, for example of titanium or of stainless steel. Alternatively it would also be conceivable that the vessel bottom and the sidewall are made of glass, for example borosilicate glass or quartz glass, or of a plastic, for example of polyether ether ketone (PEEK). The reaction vessel, in particular the vessel bottom and the sidewall, may be implemented in a double-wall fashion. The reaction vessel may have a rectangular plan view. Preferably the reaction vessel may have an oval plan view, for example a round or elliptic plan view. Preferably the reaction vessel comprises at least one connection unit with at least one connection element, which adjoins the sidewall in an upper region and is in particular implemented integrally with the sidewall. The inner vessel space could be, in particular pressure-tightly, closable, for example by a cover of the connection unit. Alternatively or additionally it would also be conceivable that further units of the reactor device and/or of the reactor comprising the reactor device could be connected to the reaction vessel by means of the connection unit. For example, a fume hood and/or a mixing unit and/or input lines and/or output lines could be connected to the reaction vessel by means of the connection unit. Preferably the reaction vessel is configured for operating pressures of at least 5 bar, an operation of the reaction vessel at lower operating pressures being of course also conceivable. The reaction vessel may in particular also be configured for vacuum applications with very low operating pressures below 1 bar. The reaction vessel is not limited to receiving a certain type of media but is preferably configured for receiving a great variety of media, which may in particular be solid and/or liquid and/or gaseous.

The external irradiation unit comprises the at least one external radiation element and may moreover comprise at least one further external radiation element. The radiation element is configured to provide electromagnetic radiation for the irradiation of the medium within the reaction vessel. The electromagnetic radiation supplied by the external radiation element may be, for example, infrared radiation and/or visible light and/or ultraviolet radiation. Preferably the radiation supplied by the radiation element is ultraviolet radiation. The electromagnetic radiation supplied by the external radiation element may be polychromatic. Preferably the electromagnetic radiation supplied by the external radiation element is monochromatic. A wavelength of the electromagnetic radiation supplied by the external radiation element may, without being limited thereto, be adapted and/or adaptable to a type of the chemical reaction(s) that is/are to be carried out in the reaction vessel and may be, for example, 365 nm or 385 nm or 395 nm or 405 nm or 420 nm or 460 nm or 525 nm or 592 nm or 625 nm. Preferably a radiant power that can be supplied by the external radiation element is adjustable, in particular steplessly adjustable. Preferably the external radiation element is exchangeable, in particular without a tool. The external radiation element comprises at least one radiation source, which may be embodied, without being limited thereto, for example as an LED and/or as a mercury-vapor lamp and/or as an excimer lamp and/or something like that. Preferably the radiation source of the external radiation element is embodied as an LED. In an especially advantageous implementation, the at least one external radiation element is embodied as an explosion-proof external radiation element and in particular comprises at least one explosion-proof LED as a radiation source. Preferably the explosion-proof external radiation element is certified according to ATEX and/or IECEx. Such an implementation advantageously allows providing a reactor device for safe usage in explosion-endangered areas. The at least one external radiation element and further external radiation elements of the external irradiation unit may be realized at least substantially identically to one another. It would also be conceivable that the at least one external radiation element and the at least one further external radiation element differ with regard to at least one parameter, for example with regard to a kind and/or dimension of the radiation source for the supply of the electromagnetic radiation and/or with regard to a wavelength and/or a radiation intensity of the electromagnetic radiation supplied.

In the present document number words, like for example “first” and “second” put before certain terms merely serve for a distinction between objects and/or for a mutual allocation of objects but do not imply an existing total number and/or sequence of the objects. In particular, a “second object” does not necessarily imply an existence of a “first object”.

By “at least substantially” is to be understood, in this document, that a deviation from a given value is in particular less than 25%, preferably less than 10% and particularly preferentially less than 5% of the given value.

“Configured” is to mean specifically designed and/or equipped. By an object being configured for a certain function is to be understood that the object fulfills and/or executes this certain function in at least one application state and/or operation state.

It is further proposed that the reactor device comprises an internal irradiation unit arranged within the reaction vessel, with at least one internal radiation element, for the irradiation of the medium. This advantageously allows further improving efficiency. In particular, a photon density within the reaction vessel can be increased and a quantum yield of radiation-induced chemical processes within the reaction vessel can be improved. The internal radiation element is configured, in addition to the at least one external radiation element of the external irradiation unit, to supply electromagnetic radiation, for example infrared radiation and/or visible light and/or ultraviolet radiation, for an irradiation of the medium within the reaction vessel. A wavelength and/or a wavelength range and/or a radiation intensity of the electromagnetic radiation supplied by the internal radiation element may correspond to the electromagnetic radiation supplied by the at least one external radiation element. It would also be conceivable that the at least one external radiation element and the at least one internal radiation element differ with regard to at least one parameter, for example with regard to a kind and/or dimension of the radiation source for supplying the electromagnetic radiation, and/or with regard to a wavelength and/or a radiation intensity of the electromagnetic radiation supplied. For example, the internal radiation element could be configured to emit pulsed radiation. The internal radiation element comprises at least one radiation source which could be embodied, without being limited thereto, for example as an LED and/or a mercury-vapor lamp and/or an excimer lamp and/or something like that. In an especially advantageous implementation, the internal radiation element is embodied as an explosion-proof internal radiation element and in particular comprises at least one explosion-proof LED as a radiation source. Preferably the explosion-proof internal radiation element is certified according to ATEX and/or IECEx. This advantageously allows providing a reactor device for safe usage in explosion-endangered areas. Preferably a radiant power that can be supplied by the internal radiation element is, in particular steplessly, adjustable. This advantageously allows precise adjustment of a desired radiant power, thus attaining particularly flexible adaption to different photochemical reactions. Preferably the internal radiation element comprises a jacket tube which is transmissive for electromagnetic radiation and in which the at least one radiation source is arranged, in particular for a protection against influences by the medium in the reaction vessel. The jacket tube could be made, for example, of quartz glass or borosilicate glass. It would be conceivable that the jacket tube comprises an optical filter, for example a gradient filter and/or an edge filter and/or a polarization filter and/or the like, for a modification of the electromagnetic radiation supplied by the internal radiation element. In addition to the at least one internal radiation element, the internal irradiation unit may comprise at least one further internal radiation element. The at least one internal radiation element and the further internal radiation element of the internal irradiation unit may be implemented at least substantially identically to one another. It would also be conceivable that the at least one internal radiation element and the at least one further internal radiation element differ with regard to at least one parameter, for example with regard to a kind and/or dimension of the radiation source for supplying the electromagnetic radiation and/or with regard to a wavelength and/or a radiation intensity of the electromagnetic radiation supplied. The internal irradiation unit may be fixedly installed in the reaction vessel. Preferably the internal irradiation unit is fastened releasably in the reaction vessel, in particular by means of the connection unit. This advantageously allows the reactor device being operated with or without an internal irradiation unit depending on requirements, thus increasing flexibility even further.

The reaction vessel may be implemented so as to be section-wise or completely transparent and transmissive for electromagnetic radiation. However, in an advantageous implementation it is proposed that the reaction vessel comprises at least one irradiation window which is transmissive for electromagnetic radiation, the at least one external radiation element being arranged in an environment of the irradiation window. Preferably, in a mounted state the irradiation window is oriented vertically and has a vertical extent running perpendicularly to the vessel bottom and a horizontal extent running parallel to the vessel bottom. The vertical extent and the horizontal extent of the irradiation window may have substantially the same size. Preferentially, however, the vertical extent of the irradiation window is greater than the horizontal extent of the irradiation window, in particular by a factor of at least 2, advantageously by a factor of at least 3, especially advantageously by a factor of at least 4, preferably by a factor of at least 5 and particularly preferentially by a factor of at least 6. This advantageously enables an especially selective and efficient irradiation of the medium. Preferably the external radiation element is arranged in the environment of the irradiation window in such a way that electromagnetic radiation generated by the external radiation element can enter the reaction vessel through the irradiation window at least partially, in particular by a fraction of at least 60%, advantageously by a fraction of at least 70%, especially advantageously by a fraction of at least 80%, preferably by a fraction of at least 90% and particularly preferentially by a fraction of at least 95%. An optical filter, for example a gradient filter and/or an edge filter and/or a polarization filter and/or something like that, could be arranged at the irradiation window for a modification of the electromagnetic radiation supplied by the external radiation element. It is also conceivable that the reactor device comprises at least one heating element and/or at least one cooling element for heating and/or cooling the irradiation window. The heating element and/or the cooling element may be arranged at the irradiation window or may be integrated in the irradiation window. The reaction vessel may comprise a plurality of irradiation windows. Preferably a number of irradiation windows corresponds to a number of external radiation elements of the external irradiation unit. Preferentially the reaction vessel has three irradiation windows, which are arranged offset to each other in a circumferential direction of the reaction vessel. However, alternatively a reaction vessel with less than three or more than three irradiation windows would also be conceivable. Preferably a total window surface area, transmissive for electromagnetic radiation, of all irradiation windows of the reactor device is equivalent to maximally 10% of a lateral surface area of the reaction vessel. The external irradiation unit could be configured to irradiate the entire inner vessel space of the reaction vessel through the irradiation window/s. In an advantageous implementation, however, the external irradiation unit is configured for a partial irradiation of the inner vessel space, wherein the irradiation window/s is/are arranged in such a way that in an operating state of the reactor device at least one first subregion of the inner vessel space is irradiated by the external irradiation unit and at least one second subregion of the inner vessel space is not irradiated. In this implementation and if the reactor device is operated without an additional internal irradiation unit, a subvolume of the medium, which is in the operating state set in motion in the inner vessel space, in particular by means of a mixing unit of the reactor device, alternatingly goes through irradiated and non-irradiated subregions of the inner vessel space and is herewith subjected to a partial irradiation, which is in particular comparable to a pulsed irradiation. Such an implementation is in particular suitable for a very efficient execution of photochemical reactions with low photon requirement, for example for chlorination, in which a permanent irradiation of the medium is not necessarily required. It is thus advantageously possible to obtain particularly high quantum yield and to improve efficiency further. Preferably, in regions outside the irradiation window/s, the reaction vessel is not transmissive for electromagnetic radiation, in particular realized as UV radiation and/or visible light and/or infrared radiation. This advantageously enables increased operational safety in an operation of the reactor device, as dangers for humans and/or the risk of damaging objects in the environment of the reaction vessel, caused by the electromagnetic radiation, are reduced, preferably minimized.

The irradiation window could be arranged, for example, in a cover or in a vessel bottom of the reaction vessel. However, in an especially advantageous implementation it is proposed that the irradiation window is arranged in a sidewall of the reaction vessel. Such an implementation advantageously allows achieving particularly selective irradiation of the medium, thus improving efficiency further.

Furthermore it is proposed that the external radiation element comprises at least one LED. This advantageously allows further improving efficiency, in particular energy efficiency, of the reactor device. It is in particular possible to provide a cost-efficient external irradiation unit. Preferably the external radiation element comprises a high-performance LED array with a power of at least 75 Watt. In a further advantageous implementation, it is proposed that the external radiation element comprises a mercury-vapor lamp. This advantageously allows further improving efficiency, in particular as an especially high radiant power can be provided. The mercury-vapor lamp in particular has a power of at least 500 Watt, advantageously of at least 600 Watt, especially advantageously of at least 700 Watt, preferably of at least 800 Watt and particularly preferentially of at least 900 Watt. The external irradiation unit may comprise exclusively external radiation elements with LEDs or exclusively external radiation elements with mercury-vapor lamps. It is also conceivable that at least one external radiation element comprises an LED and at least one further external radiation element comprises a mercury-vapor lamp. Alternatively or additionally, it would also be conceivable that at least one external radiation element of the external irradiation unit comprises a different kind of radiation source, for example an excimer lamp.

It is moreover proposed that the reactor device comprises a mixing unit for a mixing of the medium, which generates in a proximity of the irradiation window a mixing rate that is increased relative to an average mixing rate. Such an implementation advantageously allows further improving efficiency of the reactor device. The mixing unit comprises at least one mixing element, which is configured to set the medium in the reaction vessel in motion for a mixing. The mixing unit may comprise at least one mixing element that is embodied as a pump. Preferably the mixing unit comprises at least one mixing element that is embodied as a stirring element. The mixing unit is preferentially designed for a mixing of high-viscous media, in particular media having a dynamic viscosity of at least 1,000 mPa s, advantageously of at least 10,000 mPa s, especially advantageously of at least 20,000 mPa s, preferably of at least 40,000 mPa s and particularly preferentially of at least 50,000 mPa s. The mixing unit is in particular designed for a mixing of high-viscous media having a dynamic viscosity of up to 1,000,000 mPa s. In an operating state of the reactor device, the mixing unit sets the medium in the reaction vessel in motion, wherein the medium has different speeds, in particular flow speeds and/or shear rates, in different subvolumes of the reactor device. A mixing rate in a subvolume of the stirring vessel is characterized by an average speed, in particular an average flow speed and/or shear rate, of the medium in the subvolume. Accordingly, the average mixing rate of the medium is characterized by a speed of the medium averaged over the entire volume of the reaction vessel. Preferably the mixing unit creates in the proximity of the irradiation window a mixing rate that is increased relative to the average mixing rate by at least 5%, advantageously by at least 10%, especially advantageously by at least 15%, preferably by at least 20% and particularly preferentially by at least 25%. Preferably the proximity has the shape of an imaginary hollow cylinder whose width, starting from an inner wall of the reaction vessel, is a distance that runs perpendicularly to the inner wall and corresponds to at least 10% of an inner diameter of the reaction vessel, and whose height extends from the vessel bottom at least as far as an upper edge of the irradiation window.

It is further proposed that the reactor device comprises at least one close-to-the-wall scraper, which is arranged within the reaction space, for removing depositions of the medium on an inner wall of the reaction vessel. Such an implementation advantageously allows further improving efficiency of the reactor device. It is in particular achievable that the at least one irradiation window is kept free of depositions of the medium, such that an intensity of an irradiation of the medium by the external radiation element through the irradiation window can be kept substantially constant over a desired period. It is moreover proposed that the scraper has the shape of a planar elliptic ring segment. Such an implementation advantageously allows achieving especially efficient removal of depositions. In particular, especially favorable adaption to an inner contour of the reaction vessel is attainable if the scraper has the shape of a planar elliptic ring segment. Preferably the reactor device comprises at least one further close-to-the-wall scraper arranged within the reaction space for removing depositions of the medium on the inner wall of the reaction vessel. Preferably the further close-to-the-wall scraper is embodied at least substantially identically to the close-to-the-wall scraper and is arranged on a rotation axis of the mixing unit offset from the close-to-the-wall scraper by 180°, in particular in such a way that the close-to-the-wall scraper is transferable into the further close-to-the-wall scraper by a 180° rotation around the rotation axis. Preferably the close-to-the-wall scraper and the possibly existing further close-to-the-wall scraper are allocated to the mixing unit.

The close-to-the-wall scraper may be oriented parallel to a rotation axis of the mixing unit. In an advantageous implementation it is however proposed that the close-to-the-wall scraper is oriented at an angle with respect to the rotation axis of the mixing unit. This advantageously allows improving efficiency even further. Preferably the scraper is oriented at an angle with respect to the rotation axis of the mixing unit in such a way that a main extent direction of the close-to-the-wall scraper includes with the rotation axis an acute inclination angle, in particular an inclination angle between 20° and 80°, advantageously between 35° and 75°, preferentially between 40° and 70°. By a “main extent direction” of an object is herein a direction to be understood that runs parallel to a longest edge of a smallest rectangular cuboid which just still completely encloses the object.

Furthermore it is proposed that a distance of the close-to-the-wall scraper from the inner wall amounts to maximally 10% of an inner diameter of the reaction vessel. Such an implementation advantageously allows further improving efficiency with regard to the removal of depositions of the medium on the inner wall of the reaction vessel. In particular, the distance of the close-to-the-wall scraper from the inner wall amounts to maximally 9%, advantageously maximally 8%, especially advantageously maximally 7%, preferably maximally 6% and particularly preferentially maximally 5% of the inner diameter of the reaction vessel.

Beyond this it is proposed that the reactor device comprises a drive unit with a drive shaft for driving the close-to-the-wall scraper, which is connected to the drive shaft only in a lower region via a web of the drive unit. Such an implementation advantageously allows further improving efficiency, in particular as a particularly efficient utilization of the inner vessel space of the reaction vessel is enabled. It is moreover proposed that the internal radiation source is arranged at least partially between the close-to-the-wall scraper and the drive shaft. This advantageously allows further improving efficiency, in particular as a particularly efficient utilization of the inner vessel space of the reaction vessel is enabled. Moreover, an efficient irradiation is advantageously rendered possible, even in regions outside the proximity of the irradiation window which cannot be reached sufficiently or cannot be reached at all by the electromagnetic radiation supplied by the external irradiation unit. Preferably, in an operation state the at least one internal radiation element is arranged within the reaction vessel stationarily, at least partially between the close-to-the-wall scraper and the drive shaft, the at least one close-to-the-wall scraper rotating in the reaction vessel around the internal radiation element without contacting the internal radiation element. Alternatively, it would be conceivable that the close-to-the-wall scraper is additionally connected to the drive shaft in an upper region via a further web. In a further alternative implementation, it is conceivable that the close-to-the-wall scraper and the further close-to-the-wall scraper are connected to each other in the upper region by a ring, wherein the internal radiation source may be arranged at least partially between the ring and the drive shaft.

The invention further concerns a reactor, in particular a photoreactor, with a reactor device according to one of the afore-described implementations. Such a reactor is in particular distinguished by the afore-described advantageous characteristics of the reactor device.

The invention is furthermore based on a method for carrying out photochemical reactions with a reactor device, in particular a reactor device according to one of the afore-described implementations, comprising a reaction vessel for receiving at least one medium.

It is proposed that the medium within the reaction vessel is irradiated by means of an external irradiation unit, which is arranged outside the reaction vessel, with at least one external radiation element. Such an implementation advantageously allows providing an especially efficient and flexible method for carrying out photochemical reactions.

The reactor device according to the invention shall herein not be limited to the application and implementation described above. In particular, in order to realize a functionality that is described here, the reactor device according to the invention may comprise a number of individual elements, components and units that differs from a number given here.

### DRAWINGS

Further advantages will become apparent from the following description of the drawings. In the drawings an exemplary embodiment of the invention is illustrated. The drawings, the description and the claims contain a plurality of features in combination. Someone skilled in the art will purposefully also consider the features separately and will find further expedient combinations.

It is shown in:

FIG. 1 a reactor with a reactor device comprising a reaction vessel and an external irradiation unit, in a schematic perspective view,

FIG. 2 a schematic illustration of the reactor device with a drive unit, a mixing unit and an internal irradiation unit, and

FIG. 3 a schematic flow chart of a method for carrying out photochemical reactions with the reactor device.

### DESCRIPTION OF THE EXEMPLARY EMBODIMENT

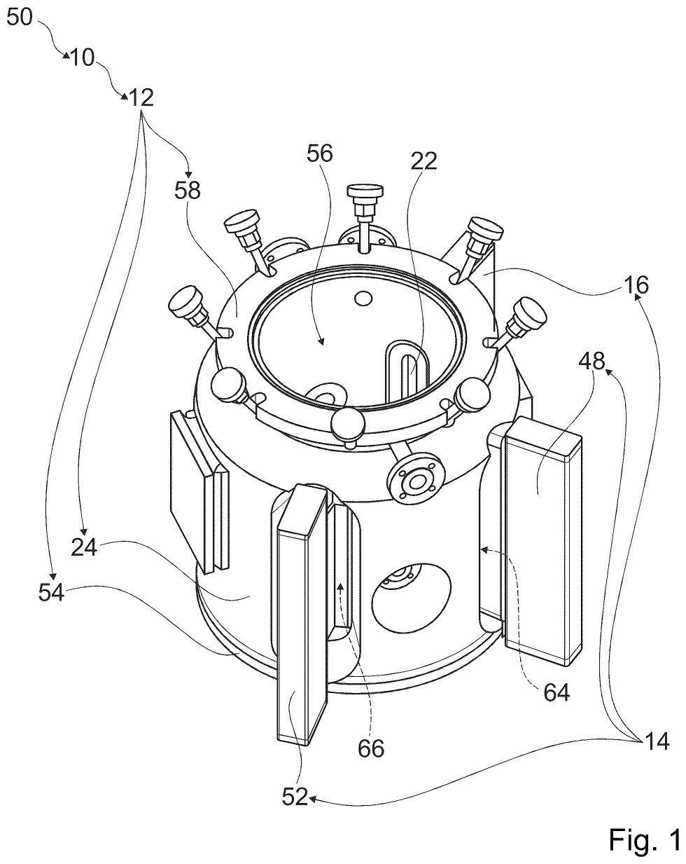

FIG. 1 shows a reactor 50 in a schematic perspective view. The reactor 50 is embodied as a photoreactor. The reactor 50 comprises a reactor device 10, which is embodied as a photoreactor device.

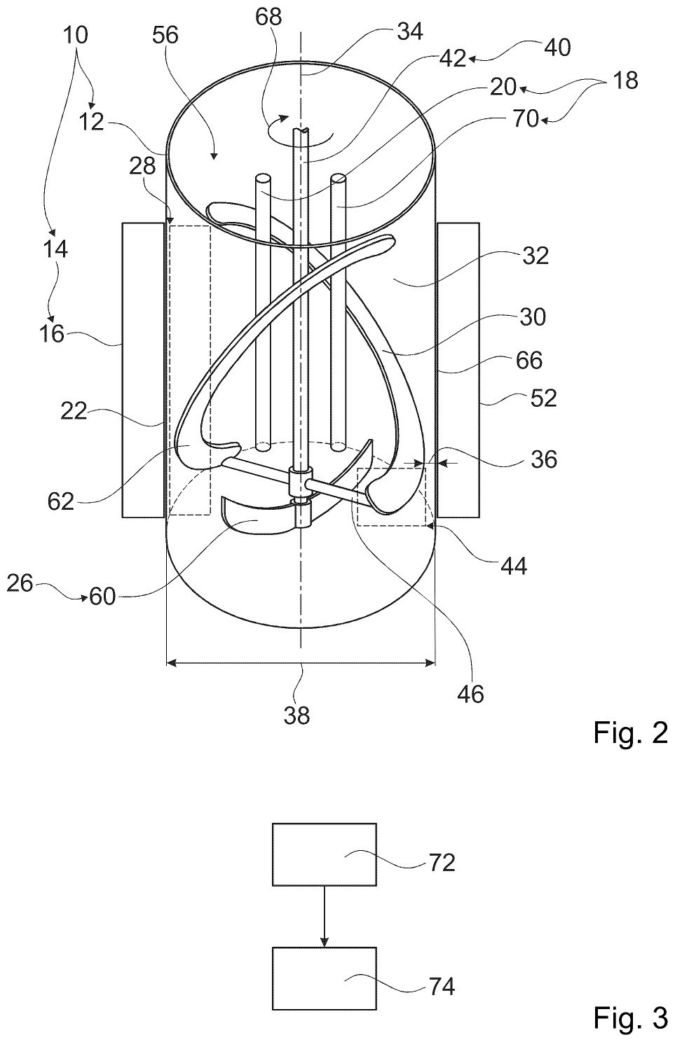

The reactor device 10 comprises a reaction vessel 12. The reaction vessel 12 is configured for receiving at least one medium (not shown). The reaction vessel 12 has a vessel bottom 54 and a circumferential sidewall 24 that adjoins the vessel bottom 54. The vessel bottom 54 and the sidewall 24 are implemented integrally and together form an inner vessel space 56. The reaction vessel 12 comprises a connection unit 58, which adjoins the sidewall 24 in an upper region. By means of the connection unit 58, the inner vessel space 56 can be closed in a pressure-tight manner, for example by means of a cover (not shown), or further units, for example a drive unit 40 (cf. FIG. 2) of the reactor device 10 or a fume hood (not shown), can be connected to the reaction vessel 12.

The reactor device 10 comprises an external irradiation unit 14, which is arranged outside the reaction vessel 12. In the present case, the external irradiation unit 14 is arranged outside the inner vessel space 56 on an outer side of the reaction vessel 12. The external irradiation unit 14 comprises at least one external radiation element 16 for an irradiation of the medium within the reaction vessel 12. In the present case, the external irradiation unit 14 comprises in total three external radiation elements, namely the external radiation element 16 and two further external radiation elements 48, 52. Alternatively, however, a smaller or greater number of external radiation elements would be conceivable. The external radiation element 16 and the further external radiation element 52 in each case have an LED (not shown). The external radiation element 48 has a mercury-vapor lamp (not shown).

The reaction vessel 12 comprises at least one irradiation window 22. The irradiation window 22 is arranged in the sidewall 24 of the reaction vessel 12. The irradiation window 22 is transmissive for electromagnetic radiation. The external radiation element 16 is arranged in an environment of the irradiation window 22, that is to say outside the inner vessel space 56. In the present case, the reaction vessel 12 comprises two further irradiation windows 64, 66, which are also arranged in the sidewall 24 of the reaction vessel 12 and are implemented at least substantially identically to the irradiation window 22. The further external radiation element 48 is arranged in the environment of a further irradiation window 64 outside the inner vessel space 56. The further external radiation element 52 is arranged in an environment of a further irradiation window 66 outside the inner vessel space 56.

In an operating state of the reactor device 10, the medium in the inner vessel space 56 is irradiated with electromagnetic radiation, for example ultraviolet radiation. The electromagnetic radiation is in the operating state generated by the external radiation element 16 and the further external radiation elements 48, 52, enters the inner vessel space 56 via the irradiation window 22, respectively via the further irradiation windows 64, 66, and meets the medium in the inner vessel space 56.

FIG. 2 shows the reactor device 10 in a very simplified schematic illustration. The reactor device 10 comprises a mixing unit 26 for a mixing of the medium. The mixing unit 26 is arranged within the reaction vessel 12, that is to say in the inner vessel space 56. The mixing unit 26 comprises a stirring element 60. In the operating state of the reactor device 10, in a mixing of the medium, the stirring element 60 rotates around a rotation axis 34 of the mixing unit 26. Herein the mixing unit 26 generates, in particular by means of the stirring element 60, a mixing rate in a proximity 28 of the irradiation window 22 that is increased with respect to an average mixing rate. The medium has in the proximity 28 a speed that is increased with respect to an average speed. Thus, in the operating state of the reactor device 10 a residence time of individual particles of the medium in the proximity 28 is short, such that an excess irradiation with the electromagnetic radiation supplied by the external irradiation unit 14, which could cause undesired side reactions, is prevented. In the same manner the mixing unit 26 also generates a mixing rate in further proximities (not shown) of the further irradiation windows 64, 66 that is increased relative to the average mixing rate.

The reactor device 10 comprises a close-to-the-wall scraper 30 that is arranged within the reaction vessel 12. The close-to-the-wall scraper 30 is configured for removing depositions of the medium on an inner wall 32 of the reaction vessel 12. A distance 36 of the close-to-the-wall scraper 30 from the inner wall 32 amounts to maximally 10% of an inner diameter 38 of the reaction vessel 12. The close-to-the-wall scraper 30 has the shape of an elliptic ring segment. The close-to-the-wall scraper 30 is oriented at an angle with respect to the rotation axis 34 of the mixing unit 26. In the present case the close-to-the-wall scraper 30 is oriented at an inclination angle of about 45° with respect to the rotation axis 34, larger or smaller inclination angles being also conceivable.

The reactor device 10 comprises a further close-to-the-wall scraper 62. The further close-to-the-wall scraper 62 is implemented substantially identically to the close-to-the-wall scraper 30 and also has the shape of an elliptic ring segment. The further close-to-the-wall scraper 62 is arranged with respect to the close-to-the-wall scraper 30 on an opposite side of the rotation axis 34. The further close-to-the-wall scraper 62 also has the distance 36 from the inner wall 32 of the reaction vessel 12 and is also oriented at an angle relative to the rotation axis 34, also at an inclination angle of about 45°. In an imaginary rotation by 180° in a rotation direction 68 around the rotation axis 34, the close-to-the-wall scraper 30 and the further close-to-the-wall scraper 62 could be transferred into one another.

In the present case the scraper 30 and the further scraper 62 in each case are part of the mixing unit 26 and, besides the removal of depositions of the medium on the inner wall 32 of the reaction vessel 12, they also help with the mixing of the medium. In the operating state of the reactor device 10, the close-to-the-wall scraper 30 and the further close-to-the-wall scraper 62 rotate in the rotation direction 68 around the rotation axis 34 close to the inner wall 32, thus relieving the inner wall 32 from depositions. In addition to the inner wall 32, the irradiation window 22, the further irradiation window 64 (see FIG. 1) and the further irradiation window 66 are also relieved from depositions of the medium by the close-to-the-wall scraper 30 and the further close-to-the-wall scraper 62, such that the electromagnetic radiation supplied by the external irradiation unit 14 can enter the inner vessel space 56 through the irradiation windows 22, 64, 66 mostly without encumbrance. In FIG. 2 a righthanded operation of the mixing unit 26 is illustrated, in which the scraper 30 and the further scraper 62 rotate around the rotation axis 34 in the rotation direction 68, thus conveying the medium from below to the top. The mixing unit 26 is also configured for lefthanded operation (not shown), in which the scraper 30 and the further scraper 62 rotate around the rotation axis 34 against the rotation direction 68 shown in FIG. 2, thus conveying the medium from top to bottom. In the operating state a change between righthanded and lefthanded operation may be provided, in particular in order to achieve further improved removal of depositions of the medium on the irradiation windows 22, 64, 66 and/or the inner wall 32 and/or to avoid accumulations of the medium in subregions of the inner vessel space 56.

The reactor device 10 comprises the drive unit 40. The drive unit 40 comprises a drive shaft 42 for driving the scraper 30 and the further scraper 62. The scraper 30 is only in a lower region 44 connected to the drive shaft 42 via a web 46 of the drive unit 40. The further scraper 62 is only in a further lower region (not shown) connected to the drive shaft 42 via the web 46 of the drive unit 40. The web 46 is connected to the drive shaft 42 via a hub.

The drive unit 40 is moreover configured for driving the mixing unit 26. In the operating state the drive shaft 42 rotates around the rotation axis 34, thus driving the scraper 30, the further scraper 62 and the stirring element 60 for a rotary movement around the rotation axis 34.

The reactor device 10 comprises an internal irradiation unit 18. The internal irradiation unit 18 is arranged within the reaction vessel 12. The internal irradiation unit 18 comprises at least one internal radiation element 20 for an irradiation of the medium. The internal radiation element 20 comprises at least one LED (not shown), which is arranged within a transparent protective tube, which may for example be made of glass. In the present case the internal irradiation unit 18 comprises a further internal radiation element 70 for an irradiation of the medium. The further internal radiation element 70 is implemented substantially identically to the internal radiation element 20. The internal radiation element 20 is arranged at least partially between the close-to-the-wall scraper 30, the further close-to-the-wall scraper 62 and the drive shaft 42. The further internal radiation element 70 is also arranged at least partially between the close-to-the-wall scraper 30, the further close-to-the-wall scraper 62 and the drive shaft 42 but on an opposite side of the drive shaft 42 than the internal radiation element 20. The internal radiation element 20 and the further internal radiation element 70 are arranged stationarily within the reaction vessel 12. In the operating state of the reactor device 10, the close-to-the wall scraper 30 and the further close-to-the wall scraper 62 rotate in the rotation direction 68 around the internal radiation element 20 and the further internal radiation element 70 without contacting the internal radiation elements 20, 70.

Alternatively, the reactor device 10 could also be realized without the internal irradiation unit 18 and could have only the external irradiation unit 14 for an irradiation of the medium.

FIG. 3 shows a schematic process flow chart of a method for carrying out photochemical reactions with the reactor device 10 comprising the reaction vessel 12 for receiving the at least one medium. The method comprises at least two method steps 72, 74. In a first method step 72 of the method the at least one medium is placed in the reaction vessel 12. In a second method step 74 of the method the medium is irradiated within the reaction vessel 12 by means of the external irradiation unit 14 that is arranged outside the reaction vessel 12.

1. A reactor device with a reaction vessel for receiving at least one medium, comprising an external irradiation unit that is arranged outside the reaction vessel, with at least one external radiation element, for an irradiation of the medium within the reaction vessel.

2. The reactor device according to claim 1, comprising an internal irradiation unit that is arranged within the reaction vessel, with at least one internal radiation element for an irradiation of the medium.

3. The reactor device according to claim 1, wherein the reaction vessel comprises at least one irradiation window which is transmissive for electromagnetic radiation, the at least one external radiation element being arranged in an environment of the irradiation window.

4. The reactor device according to claim 3, wherein the irradiation window is arranged in a sidewall of the reaction vessel.

5. The reactor device according to claim 1, wherein the external radiation element comprises at least one LED.

6. The reactor device according to claim 1, wherein the external radiation element comprises at least one mercury-vapor lamp.

7. The reactor device according to claim 1, comprising a mixing unit for a mixing of the medium, which generates in a proximity of the irradiation window a mixing rate that is increased relative to an average mixing rate.

8. The reactor device according to claim 1, comprising at least one close-to-the-wall scraper arranged within the reaction vessel for removing depositions of the medium on an inner wall of the reaction vessel.

9. The reactor device according to claim 8, wherein the close-to-the-wall scraper has the shape of a planar elliptic ring segment.

10. The reactor device according to claim 8, wherein the close-to-the-wall scraper is oriented at an angle with respect to a rotation axis of the mixing unit.

11. The reactor device according to claim 8, wherein a distance of the close-to-the-wall scraper from the inner wall amounts to maximally 10% of an inner diameter of the reaction vessel.

12. The reactor device according to claim 8, comprising a drive unit with a drive shaft for driving the close-to-the-wall scraper, which is connected to the drive shaft only in a lower region via a web of the drive unit.

13. The reactor device according to claim 12, comprising an internal irradiation unit that is arranged within the reaction vessel, with at least one internal radiation element for an irradiation of the medium, wherein the internal radiation element is arranged at least partially between the close-to-the-wall scraper and the drive shaft.

14. A reactor, in particular a photoreactor, with a reactor device according to claim 1.

15. A method for carrying out photochemical reactions with a reactor device comprising a reaction vessel for receiving at least one medium, wherein the medium within the reaction vessel is irradiated by means of an external irradiation unit that is arranged outside the reaction vessel, with at least one external radiation element.

16. A method for carrying out photochemical reactions with a reactor device according to claim 1, comprising a reaction vessel for receiving at least one medium, wherein the medium within the reaction vessel is irradiated by means of an external irradiation unit that is arranged outside the reaction vessel, with at least one external radiation element.
